(19) United States
(12) Patent Application Publication
(10) Pub. No.: US 2026/0002827 A1
(43) Pub. Date: Jan. 1, 2026

(54) TRIVIAL TRANSMITTER MODEL

(71) Applicant: Steven J. Troccoli, Round Rock, TX (US)

(72) Inventor: Steven J. Troccoli, Round Rock, TX (US)

(21) Appl. No.: 18/760,625

(22) Filed: Jul. 1, 2024

(51) Int. Cl. G01L 27/00; G01L 27/02; G06N 3/048

(52) U.S. Cl. CPC G01L 27/005; G01L 27/02; G06N 3/048

(57) ABSTRACT

A trivial transmitter model enables processes to be automated and/or networks to be managed efficiently and reliably. The trivial transmitter model includes one or more interneuron units that receive a quantity of transmitters including at least a portion of a first quantity of a source transmitter released by a source unit, determine a second quantity of an interneuron transmitter based on the quantity of received transmitters including at least the portion of the first quantity of the source transmitter, and release the second quantity of the interneuron transmitter, wherein the second quantity of the interneuron transmitter is configured to perform an action upon satisfying a predetermined threshold.

### BACKGROUND

Systems and methods for conveying and/or processing information are disclosed herein. Basic data models are susceptible to underfitting, which can significantly impair performance. Consequently, known neurocomputational models are generally characterized by complexity, demanding substantial computational resources and/or energy consumption. Moreover, at least some known neurocomputational models are rigid and/or have difficulty accounting for environmental variability and, thus struggle to adapt to changes in dynamic environments.

### SUMMARY

The present disclosure enables processes to be automated and/or networks to be configured and managed dynamically, efficiently and reliably. In one aspect, a method is provided for automating one or more processes using a trivial transmitter model. The method includes receiving a quantity of transmitters including at least a portion of a first quantity of a source transmitter released by a source unit, determining a second quantity of an interneuron transmitter based on the quantity of received transmitters including at least the portion of the first quantity of the source transmitter, and releasing the second quantity of the interneuron transmitter, wherein the second quantity of the interneuron transmitter is configured to trigger a response for performing an action upon satisfying a predetermined threshold.

In another aspect, a trivial transmitter model is provided. The trivial transmitter model includes a source unit, an interneuron unit, and a motor unit. The source unit is configured to determine one or more parameters associated with an environment, determine a first quantity of a source transmitter based on the parameters, and release the first quantity of the source transmitter. The interneuron unit is configured to receive at least a portion of the first quantity of the source transmitter, determine a second quantity of an interneuron transmitter based on a quantity of received transmitters including at least the portion of the first quantity of the source transmitter, and release the second quantity of the interneuron transmitter. The motor unit is configured to receive at least a portion of the second quantity of the interneuron transmitter, determine whether a quantity of received transmitters including at least the portion of the second quantity of the interneuron transmitter satisfies a predetermined threshold, and on condition that the predetermined threshold is satisfied, perform an action.

In yet another aspect, a system is provided. The system includes a robotic device and a trivial transmitter model. The robotic device includes one or more sensors, one or more actuators, and one or more controllers configured to receive one or more first signals from the sensors and transmit one or more second signals to the actuators. The trivial transmitter model includes a source unit corresponding to the sensors, a motor unit corresponding to the actuators, and an interneuron unit corresponding to the controllers. The sensor unit is configured to determine one or more parameters associated with an environment of the robotic device, determine a first quantity of a source transmitter based on the parameters, and release the first quantity of the source transmitter. The interneuron unit is configured to receive at least a portion of the first quantity of the source transmitter, determine a second quantity of an interneuron transmitter based on a quantity of received transmitters including at least the portion of the first quantity of the source transmitter, and release the second quantity of the interneuron transmitter. The motor unit is configured to receive at least a portion of the second quantity of the interneuron transmitter, determine whether a quantity of received transmitters including at least the portion of the second quantity of the interneuron transmitter satisfies a predetermined threshold, and on condition that the predetermined threshold is satisfied, perform an action.

Other aspects and features of the present disclosure will be in part apparent and in part pointed out herein. This Summary is provided to introduce a selection of concepts in a simplified form that are further described below in the Detailed Description. This Summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail below with reference to the attached drawing figures, wherein:

FIG. 1 is a block diagram illustrating an example trivial transmitter model;

FIG. 2 is a screenshot illustrating an example interface for constructing and/or configuring a model at design-time, such as the trivial transmitter model illustrated in FIG. 1;

FIG. 3 is a screenshot illustrating an example interface for implementing a model at run-time, such as the trivial transmitter model illustrated in FIG. 1;

FIGS. 4 and 5 are screenshots illustrating example information that may be presented on an interface, such as the interface illustrated in FIG. 3;

FIG. 6 is a flowchart illustrating an example method for automating one or more processes using a model, such as the trivial transmitter model illustrated in FIG. 1;

FIG. 7 is a block diagram illustrating an example system including a robotic device in which a model, such as the trivial transmitter model illustrated in FIG. 1, may be implemented;

FIG. 8 is a photograph illustrating an example robotic device in which a model, such as the trivial transmitter model illustrated in FIG. 1, may be implemented; and

FIG. 9 is a computer architecture diagram illustrating an computing system that may be used to perform one or more computing operations using a model, such as the trivial transmitter model illustrated in FIG. 1.

Corresponding reference numbers indicate corresponding parts throughout the drawings.

### DETAILED DESCRIPTION

According to various examples of the present disclosure, a trivial transmitter model may be used to convey and/or process information. Example trivial transmitter models described herein include one or more source units, one or more interneuron units, and one or more motor units. A source unit may be used to determine one or more parameters associated with an environment, determine a first quantity of a source transmitter based on the parameters, and release the first quantity of the source transmitter. An interneuron unit may be used to receive at least a portion of the first quantity of the source transmitter, determine a second quantity of an interneuron transmitter based on a quantity of received transmitters (including at least the portion of the first quantity of the source transmitter), and release the second quantity of the interneuron transmitter. A motor unit may be used to receive at least a portion of the second quantity of the interneuron transmitter, determine whether a quantity of received transmitters (including at least the portion of the second quantity of the interneuron transmitter) satisfies a predetermined threshold, and on condition that the predetermined threshold is satisfied, perform an action. Examples described herein enable a user-friendly architecture to be configured for easy implementation and/or use in a broad range of scenarios. In this manner, the present disclosure represents a significant advancement in transmitter neural network design, offering a practical solution for creating and/or organizing neural network structures (e.g., connectomes) and processing information to enable processes to be automated and/or networks to be managed efficiently and reliably.

In some examples, the trivial transmitter models described herein may be configured to perform one or more plasticity events, changing connections of synapses between the source units, interneuron units, and/or motor units. For example, the interneuron units may add and/or remove connectivity between excitatory and/or inhibitory forces to facilitate maintaining a balance between the amount of transmitter produced and the amount of transmitter distributed. In this manner, the trivial transmitter models described may be used to facilitate the gain and loss of function and memory.

Aspects of the present disclosure provide for a computing system that performs one or more operations in an environment including a plurality of devices coupled to each other via a network (e.g., a local area network (LAN), a wide area network (WAN), the internet). The systems and methods described herein may be implemented using computer programming or engineering techniques including computer software, firmware, hardware, or a combination or subset thereof. Unless defined otherwise, all technical and scientific terms used herein have the same meaning as commonly understood by one of ordinary skill in the art to which the present disclosure belongs. Although any methods and materials similar to or equivalent to those described herein can be used in the practice or testing of the present disclosure, some preferred methods and materials are described below.

The systems and methods disclosed herein provide a technological solution to technical problems by providing an effective, streamlined mechanism for achieving high performance while reducing complexity and/or resource requirements. The technical effect of the systems and methods described herein is achieved by using a computing system configured to perform one or more of the following operations: (i) receiving a quantity of transmitters including at least a portion of a first quantity of a source transmitter released by a source unit; (ii) determining a second quantity of an interneuron transmitter based on the quantity of received transmitters including at least the portion of the first quantity of the source transmitter; and/or (iii) releasing the second quantity of the interneuron transmitter, wherein the second quantity of the interneuron transmitter is configured to trigger a response for producing an action upon satisfying a predetermined firing threshold.

As used herein, the term “transmitter” may refer to a signal, substance, or information generated and potentially released across a synapse. Generally, a transmitter may be excitatory or inhibitory in nature. A transmitter that triggers a post-synaptic response (whether excitatory or inhibitory) may be referred to as an “effective”.

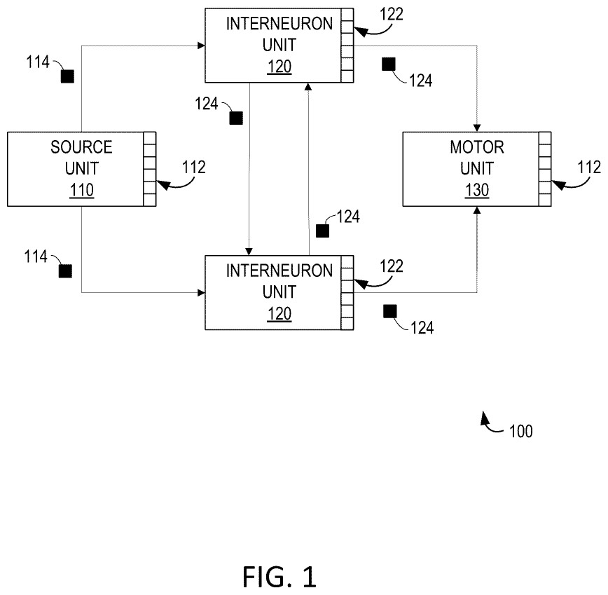

FIG. 1 shows an example trivial transmitter model 100 for automating one or more processes and/or managing a network of cells connected by synapses. As shown in FIG. 1, the trivial transmitter model 100 may include one or more first or source units 110. Each source unit 110 may include one or more source cells 112 configured to periodically release one or more source transmitters (e.g., tonally) as configured in the model, or to detect one or more environmental properties, such as light, motion, proximity, pressure, temperature, and/or humidity, and release one or more source transmitters 114 based on the environmental properties. In this manner, a source unit 110 may be configured to generate and release one or more source transmitters 114 based on one or more parameters associated with an environment. In some examples, the source unit 110 may be configured to determine a first quantity of the source transmitter 114 and release the first quantity of the source transmitter 114.

The trivial transmitter model 100 includes one or more second or interneuron units 120. Each interneuron unit 120 may include one or more interneuron cells 122 configured to receive one or more transmitters (e.g., at least a portion of the first quantity of the source transmitter 114) and potentially release one or more interneuron transmitters 124 based on the received transmitters. In this manner, an interneuron unit 120 may be configured to generate and release one or more interneuron transmitters 124 based on a quantity of inbound transmitters, which may include one or more source transmitters 114 from one or more source units 110 and/or one or more interneuron transmitters 124 from one or more other interneuron units 120. Source transmitters 114 are generally excitatory in nature, and their receipt may promote the release of interneuron transmitters 124. Additionally, some interneuron transmitters 124 are excitatory in nature, and their receipt may promote the release of other interneuron transmitters 124. However, some interneuron transmitters 124 are inhibitory in nature, and their receipt may inhibit the release of other interneuron transmitters 124. In some examples, the interneuron unit 120 may be configured to determine a second quantity of the interneuron transmitter 124 based on a quantity of received transmitters (e.g., including at least a portion of the first quantity of the source transmitter 114) and release the second quantity of the interneuron transmitter 124.

The trivial transmitter model 100 includes one or more motor units 130. Each motor unit 130 may include one or more motor cells 132 configured to receive one or more transmitters (e.g., at least a portion of the second quantity of the interneuron transmitter 124) and potentially perform an action (e.g., movement, inhibition of movement). In this manner, a motor unit 130 may be configured to perform an action based on a quantity of inbound transmitters, which may include one or more interneuron transmitters 124 from one or more interneuron units 120. Interneuron transmitters 124 received by the motor cells 132 are generally excitatory in nature and may be aggregated or combined from one or more interneuron units 120. In some examples, a motor unit 130 may be configured to determine when to perform an action by comparing the quantity of inbound transmitters with a predetermined firing threshold. In this manner, the motor unit 130 may be configured to perform the action upon determining that the predetermined firing threshold is satisfied (e.g., when the quantity of inbound transmitters is greater than or equal to the predetermined firing threshold).

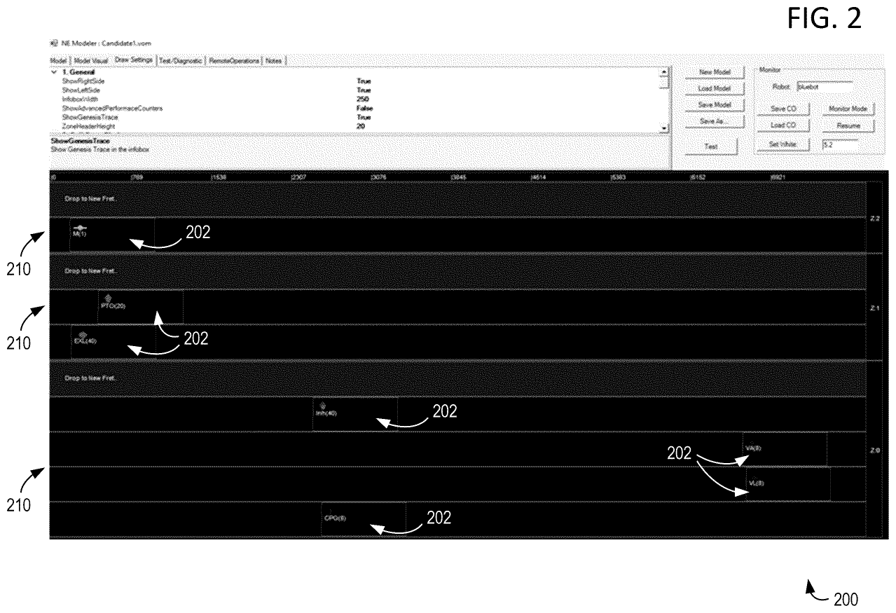

FIG. 2 shows a design-time interface 200 in which a trivial transmitter model 100 may be constructed and/or configured. In some examples, the trivial transmitter model 100 may include a collection of cells and/or parameters that persist in a “virtual organism model” (*.vom) file. The design-time interface 200 may be used, for example, to design an artificial organism using a plurality of units 202 (e.g., source unit 110, interneuron unit 120, motor unit 130). In some examples, the design-time interface 200 may allow a user to select or define a type, productive capacity, and/or configuration for each unit 202. Example types of source units 110 may include central pulse generators, or environmental proprioceptive sensors such as visual, vestibular, proximity, pressure, thermal, and/or humidity. Example types of interneuron units 120 may include excitatory and/or inhibitory. Other types of units 202 may include a test tissue configurable to introduce various patterns (e.g., oscillating, spike, constant, etc.) into the trivial transmitter model 100, and/or musculature for performing one or more actions.

The design-time interface 200 is configured to allow for the spatial and temporal placement of the units 202. In some examples, the units 202 may be arranged or organized into a plurality of zones 210. For example, the zones 210 may be defined or distinguished vertically (e.g., by height or elevation). Additionally or alternatively, the zones 210 may be defined or distinguished laterally or horizontally (e.g., left or right). In this manner, the trivial transmitter model 100 may be used to define a bilateral virtual organism. While the example shown in FIG. 2 includes three zones 210 (i.e., Zone 0, Zone 1, and Zone 2), the zones 210 may be spatially placed in any other manner that enables the design-time interface 200 to function as described herein.

In some examples, the zones 210 define where one or more transmitters (e.g., source transmitter 114, interneuron transmitter 124) may be sent and/or received. For example, a unit 202 may be configured to receive transmitters in a zone 210 in which it resides and/or transmit transmitters to a zone 210 in which it resides and/or to another zone 210. In some examples, each unit 202 may have a polarity that defines a direction it is inclined or configured to send transmitters. For example, a unit 202 with a local polarity may be configured to send transmitters in the zone 210 in which it resides, whereas a unit 202 with an ascending polarity may be configured to send transmitters towards a zone 210 above (e.g., from Zone 1 to Zone 2), a unit 202 with a descending polarity may be configured to send transmitters towards a zone 210 below (e.g., from Zone 2 to Zone 1), and a lateral polarity may be configured to send transmitters towards a zone 210 on the opposite side (e.g., from Zone 1 Left to Zone 1 Right).

In some examples, one or more units 202 may be configured to arrive or be presented in the trivial transmitter model 100 at a predetermined time after an initial time “0”. For example, an arrival time for a particular unit 202 may be represented by its position in the design-time interface 200 along the X-axis (e.g., horizontally). In this manner, a user may determine or select an earlier arrival time for a unit 202 by positioning it towards the left and/or a later arrival time for the unit 202 by positioning it towards the right.

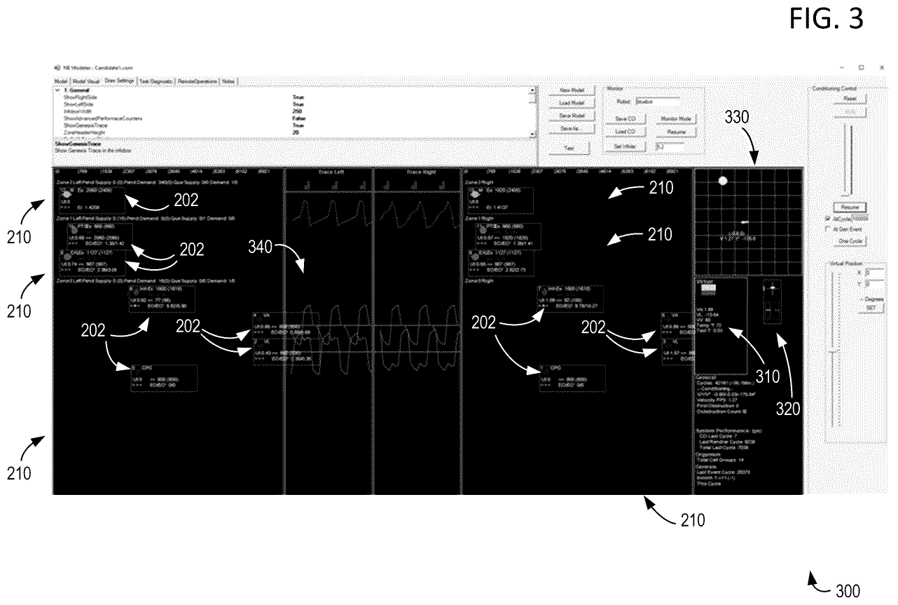

FIG. 3 shows a run-time interface 300 in which the trivial transmitter model 100 may be implemented to operate the artificial organism in a virtual environment. The virtual environment may be used, for example, to simulate one or more environmental conditions. In some examples, the run-time interface 300 may include a window 310 in which a state of the virtual environment (e.g., visual accelerometer, temperature) may be presented. Additionally or alternatively, the run-time interface 300 may include a window 320 in which a state of the artificial organism (e.g., motor activation, accelerometer activity) may be presented and/or a window 330 in which a position and/or orientation of the artificial organism within the virtual environment may be presented. In this manner, the run-time interface 300 may be used to observe a response of the artificial organism to a change in one or more environmental conditions.

As shown in FIG. 3, the run-time interface 300 may present a state and/or activity for one or more units 202. For example, each unit 202 may contain information associated with a current state and/or activity of the unit 202, and the run-time interface 300 may include a window 340 in which a historical state and/or activity of one or more units 202 may be presented. In some examples, the trivial transmitter model 100 may be configured to operate the artificial organism on a periodic cycle, wherein one or more operations may be performed per cycle. For example, within each cycle, one or more units 202 may release their transmitters via one or more synapses that allow material and/or information to be transmitted between two units 202. Transmitters that trigger a post-synaptic response may be referred to as effectives. Units 202 releasing effectives may be referred to as providers or sources, and units 202 receiving effectives may be referred to as consumers or targets. In some examples, one provider may be configured to release effectives to one or more consumers via one or more outbound synapses. Additionally, one consumer may be configured to receive effectives from one or more providers via one or more inbound synapses.

The run-time interface 300 is configured to present each unit 202 within one of the zones 210. For example, the example shown in FIG. 3 includes four units 202 in Zone 0 Left, four units 202 in Zone 0 Right, two units 202 in Zone 1 Left, two units 202 in Zone 1 Right, one unit 202 in Zone 2 Left, and one unit 202 in Zone 2 Right. Alternatively, each zone 210 may include any quantity of units 202 that enables the run-time interface 300 to function as described herein.

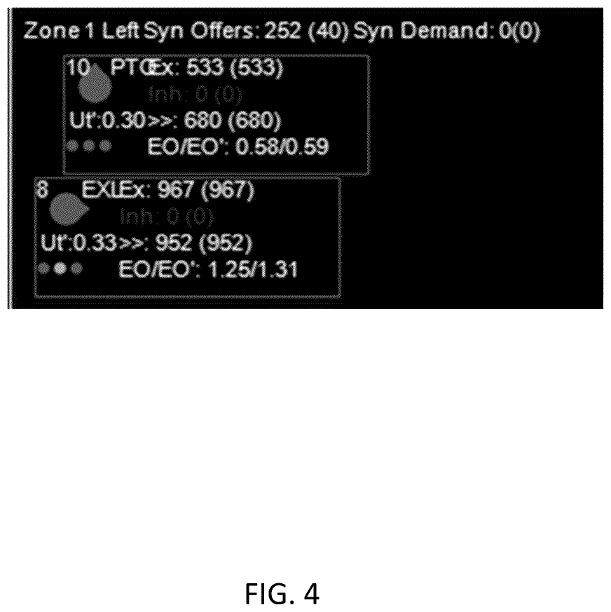

The run-time interface 300 may present a state, activity, and/or activity history for each zone 210. For example, in each zone 210, markets may exist for different types of synapses, such as excitatory and inhibitory, and the units 202 may advertise a willingness to provide and/or accept a type of synapse (e.g., excitatory, inhibitory) using the markets. In the example shown in FIG. 4, Zone 1 Left, which includes two units 202 (e.g., Group 10 and Group 8), has a pending offering of 252 excitatory synapses and 40 inhibitory synapses, alongside a current demand for 0 excitatory synapses and 0 inhibitory synapses.

When a pending offering aligns with a current demand in a zone 210, they may be coupled in a synapse grouping—a collection of synapses between zones 210—to enable a corresponding effective to be released and allow the pending offering and current demand to be fulfilled. If no synapse grouping exists between a provider and a consumer, one may be created. On the other hand, if there is an existing synapse grouping between the provider and the consumer, one or more synapses may be added to the synapse grouping to strengthen the relationship and/or connection therebetween. In a zone 210, available synapses (e.g., the pending offering) may be allocated or distributed among consumers based on demand. For example, if the pending offering is fifteen and a unit “A” demands five synapses and a unit “B” demands ten synapses, then five synapses may be allocated to unit “A” and ten synapses may be allocated to unit “B”.

During a run-time cycle, the trivial transmitter model 100 may be configured to perform a plurality of operations. In some examples, the trivial transmitter model 100 may be configured to evaluate the frequency/output of effective transmitters of the source units 110 and then the frequency/output of effectives of the interneuron units 120. Before evaluating the frequency/output of effectives the interneuron units 120, the trivial transmitter model 100 may first determine whether one or more interneuron units 120 are scheduled to arrive or be presented. Then, for each interneuron unit 120 having been presented in the trivial transmitter model 100, the trivial transmitter model 100 may check a pressure state, generate transmitters, determine inbound effectives (excitatory and inhibitory), determine outbound effectives, distribute outbound effectives among consumers, and/or make plasticity decisions to remove or dismiss cells (e.g., if it is determined that its productive capacity is underutilized and/or not required) or add and/or remove synapses.

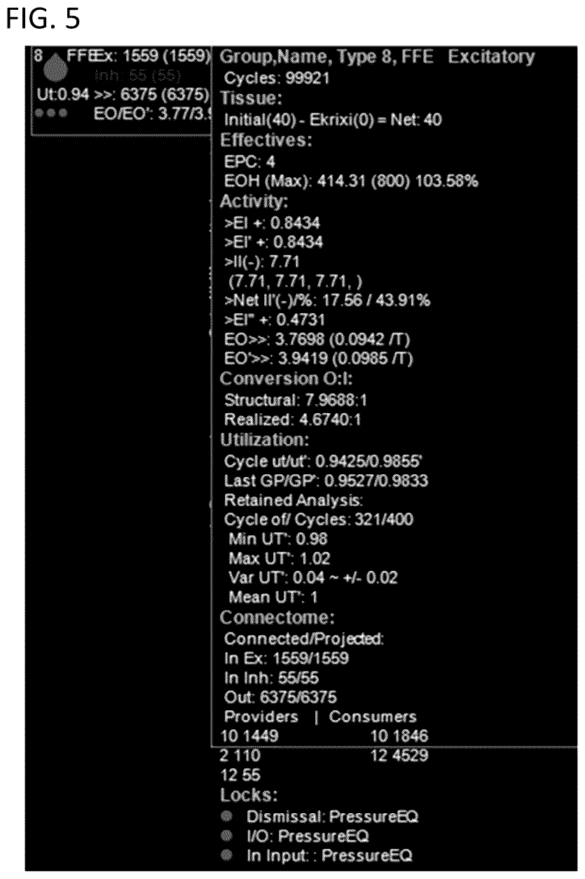

FIG. 5 shows additional information that may be presented in regard to a unit 202 (e.g., Group 8) presented on the run-time interface 300. For example, FIG. 5 shows:
The unit type is excitatory;
The unit has been online for 99,921 cycles
The unit currently has all 40 of its initial cells
The unit has a productive capacity to generate 4 effectives per cycle (EPC)
The unit currently has 414.31 effectives on hand (EOH), which is 103.58% of an operational capacity/pressure of the unit
The unit received 0.8434 excitatory effectives (EI) this cycle and 7.71 inhibitory effectives (II) each of the last three cycles, which is adjusted to 0.8434 resulting EI (EI′) and 17.56 resulting II (Net II′) after accounting for redundancies and persistence
The structural conversion rate of the unit (effectives released per effective received) is 7.9688:1, which is adjusted to a realized conversion rate of 4.6740:1 after accounting for inhibitory effectives and pressure adjustment
The unit is configured to release or has an effective output (EO) of 3.7698 effectives this cycle, but the resulting effective output (EO′) is slightly higher at 3.9419 due to the unit being slightly over pressure (e.g., EOH=103.58%)
The unit is configured to experience 0.9425 utilization (Ut) this cycle, which is adjusted to 0.9855 resulting utilization (Ut′) after accounting for pressure adjustment
The unit has 1559 excitatory inbound synapses and 55 inhibitory inbound synapses which are provided by Groups 2, 10, and 12
The unit has 6375 outbound synapses which are provided to Groups 10 and 12
The unit is in an equilibrium state

Each cycle, the unit 202 generates transmitters and potentially releases a quantity of outbound effectives. An effective output (EO) of the unit 202 may be determined based on a quantity of inbound excitatory effectives (EI) and a quantity of inbound inhibitory effectives (II). For example, the quantity of EI may represent how many cells in the unit 202 are allowed to release in the current cycle, and/or the quantity of II may represent how many cells in the unit 202 (e.g., as a percentage) which are held from release in the current cycle. In some examples, II may persist for a plurality of cycles. In this manner, the EO may be configured to decrease for each II received in the current cycle and one or more preceding cycles. For example, Group 8 shown in FIG. 5 received 7.71 II in each of the last three cycles for a net total of 23.13 II (i.e., 7.71×3).

To account for any received effectives (EI or II) that may be redundant and/or have overlapping effects (e.g., if a plurality of effectives are received at the same cell), a resulting quantity of received effectives E′ may be determined using a formula, such as the following pick-and-replace equation:

$${E}^{′} = P ( 1 - {e}^{- E / P} ) \qquad [ Eq . 1 ]$$

where P is equal to the quantity of cells in the unit 202 and E is equal to the actual quantity of received effectives (EI or II). For example, Group 8 shown in FIG. 5 received a resulting quantity of excitatory effectives (EI′) of 0.8434, where P=40 and E=0.8434, and a resulting net quantity of inhibitory effectives (Net II′) of 17.56, where P=40 and E=23.13.

In some examples, the EO may also be dictated by or determined based on a structural conversion rate of the cells in the unit 202. The structural conversion rate may be determined, for example, based on a quantity of outbound synapses and a standard efficacy or a probability of post-synaptic response (PPSR). For example, if a cell were to have 100 outbound synapses and a PPSR of 5%, its structural conversion rate would be 5:1 because, for each inbound effective it receives, it would be configured to distribute 5 effectives (i.e., 100*0.05) among its consumers. For the cells in Group 8 shown in FIG. 5, the structural conversion rate may be determined by multiplying the number of outbound synapses by the PPSR and then dividing by the number of cells in the unit 202 (i.e., 6375*0.05/40). In some examples, the EO may be determined by a realized conversion rate of the cells in the unit 202. The realized conversion rate may be determined, for example, based on a quantity of effectives received and a percentage of cells inhibited, plus or minus a pressure adjustment.

In some examples, the unit 202 may be in an equilibrium state when its productive capacity is equal to or within a predetermined quantity of its utilization and/or resulting effective output (e.g., when EPC≅EO′). When productive capacity is less than utilization (e.g., the quantity of generated effectives is less than the quantity of released effectives), the unit 202 may be deemed overutilized. Conversely, when productive capacity is greater than utilization (e.g., the quantity of generated effectives is greater than the quantity of released effectives), the unit 202 may be deemed underutilized.

In some examples, the unit 202 may be biased toward the equilibrium state. For example, when the unit 202 is not in the equilibrium state, the unit 202 may be configured to make one or more plasticity actions. The plasticity actions enable the trivial transmitter model 100 to adapt and change in response to experience. In some examples, a plasticity action may be made based on a quantity of effectives the unit 202 has “on hand” or available for release relative to an operational quantity of the unit 202.

When the unit 202 is overutilized (e.g., when EPC<EO), the quantity of effectives the unit 202 has “on hand” may decrease because the unit 202 is releasing more effectives than it is generating. If the quantity of effectives the unit 202 has “on hand” decreases below a model pressure range (e.g., at least a predetermined amount below the operational quantity), the unit 202 may be determined to be “under pressure” and advertise or call for more inhibitory effectives (e.g. II) so that the quantity of released effectives (e.g., EO) may be decreased. For example, the unit 202 may request one or more inhibitory inbound synapses for receiving one or more inhibitory effectives. In some examples, the unit 202 may request an inhibitory inbound synapse for each cell in the unit 202. If the unit 202 is overutilized and under pressure and there are no inhibitory effectives available in the zone 210 in which it resides, the unit 202 may reduce or trim the quantity of excitatory synapses (e.g., EI), or reduce or trim the number of synapses it provides to its consumers (e.g., outbound synapses), to facilitate decreasing the quantity of released effectives (EO) and regain equilibrium.

Conversely, when the unit 202 is underutilized (e.g., when EPC>EO), the quantity of effectives the unit 202 has “on hand” may increase because the unit 202 is releasing fewer effectives than it is generating. If the quantity of effectives the unit 202 has “on hand” increases above a model pressure range (e.g., at least a predetermined amount above the operational quantity), the unit 202 may be determined to be “over pressure” and advertise or call for more excitatory effectives (e.g. EI) so that the quantity of released effectives (e.g., EO) may be increased and/or it may advertise (offer) its transmitter to consumers also increasing the quantity of released effectives. For example, the unit 202 may request one or more excitatory inbound synapses for receiving one or more excitatory effectives. In some examples, the unit 202 may request an excitatory inbound synapse for each cell in the unit 202. In some examples, the unit 202 may have a predetermined limit on how many effectives it may release in one cycle. If the unit 202 is underutilized and over pressure and there are no excitatory consumers available in the zone 210 in which it targets, the unit 202 may reduce or trim the quantity of inhibitory synapses decreasing inhibitor effects (e.g., II) to facilitate increasing the quantity of released effectives and regain equilibrium.

In some examples, the unit 202 is evaluated periodically for pressure state (e.g., Ut). If the unit 202 remains underutilized for a predetermined number of cycles, the unit 202 may “dismiss” one or more cells to decrease productive capacity and facilitate achieving a more economically efficient position. The event is an “Ekrixi” (Greek: Εκρηξη), conceptualizing the over-pressure state causing an “explosion” of a cell within the unit 202.

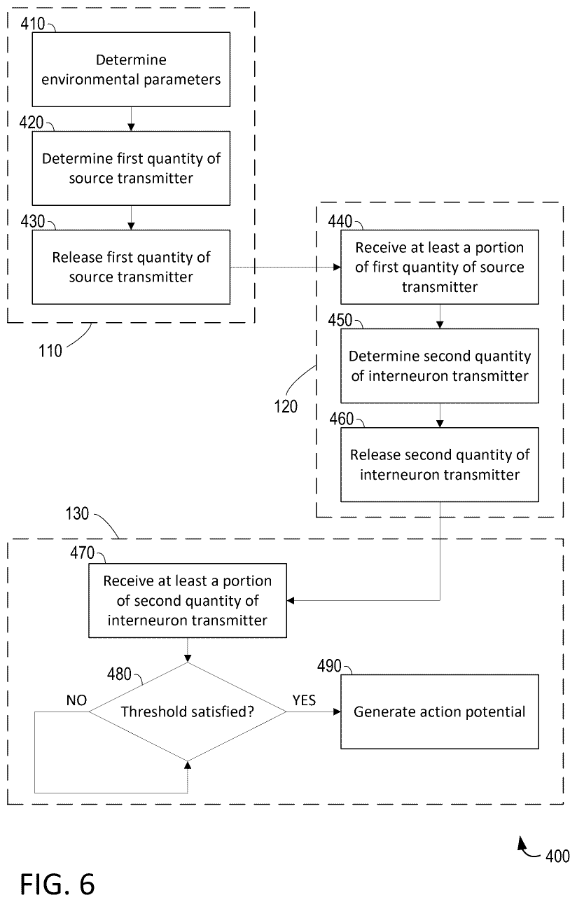

FIG. 6 shows an example method 400 for operating the artificial organism in the virtual environment. The method 400 may be implemented, for example, using the run-time interface 300.

In some examples, a first unit 202 (e.g., source unit 110) is configured to determine one or more parameters associated with central pulse generators and/or an environmental condition at operation 410, determine a first quantity of a source effective (e.g., source transmitter 114) based on the one or more parameters at operation 420, and release the first quantity of the source effective at operation 430 for distribution to one or more of its target units 202. The one or more parameters may be representative of an environmental state.

In some examples, a second unit 202 (e.g., interneuron unit 120) is configured to receive at least a portion of the first quantity of the source effective at operation 440, determine a second quantity of an interneuron effective (e.g., interneuron transmitter 124) based on a quantity of received effectives, including at least the portion of the first quantity of the source effective, at operation 450, and release the second quantity of the interneuron effective at operation 460 for distribution to one or more of its target units 202.

The second quantity of the interneuron effective may be determined based on a quantity of excitatory inbound (EI) and/or inhibitory inbound (II). For example, each EI received in the current cycle may facilitate increasing the second quantity of the interneuron effective, and/or each II received in the current cycle may facilitate decreasing the second quantity of the interneuron effective. Additionally, in some examples, each II received in the preceding one or more cycles may also facilitate decreasing the second quantity of the interneuron effective due to a persistence of the inhibitory effectives. In some examples, an effective output (EO) may be reduced or increased by pressure adjustment to determine the second quantity of the interneuron effective (e.g., EO′).

In some examples, a third unit 202 (e.g., motor unit 130) is configured to receive at least a portion of the second quantity of the interneuron transmitter at operation 470, determine whether a quantity of received parameters (e.g., EI), including at least the portion of the second quantity of the interneuron transmitter 124, satisfies a predetermined firing threshold at operation 480, and on condition that the predetermined firing threshold is satisfied, perform an action at operation 490.

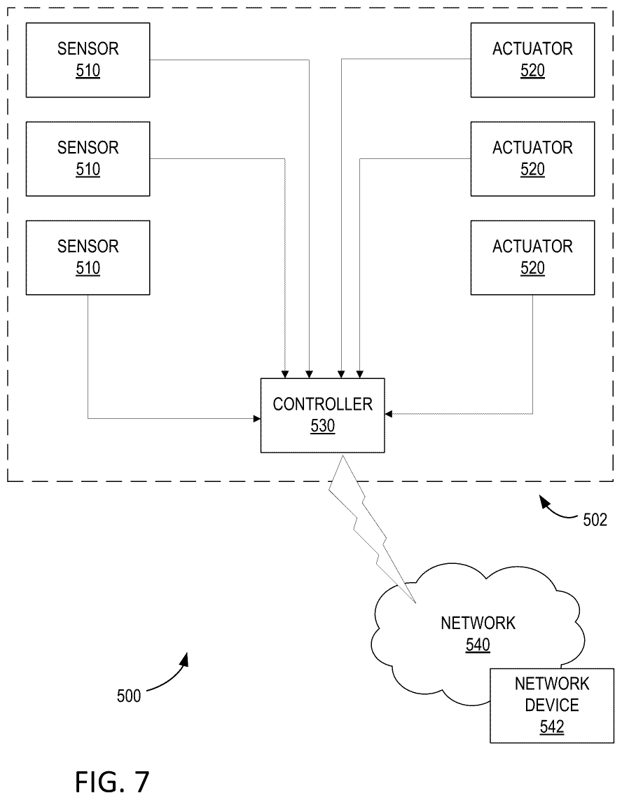

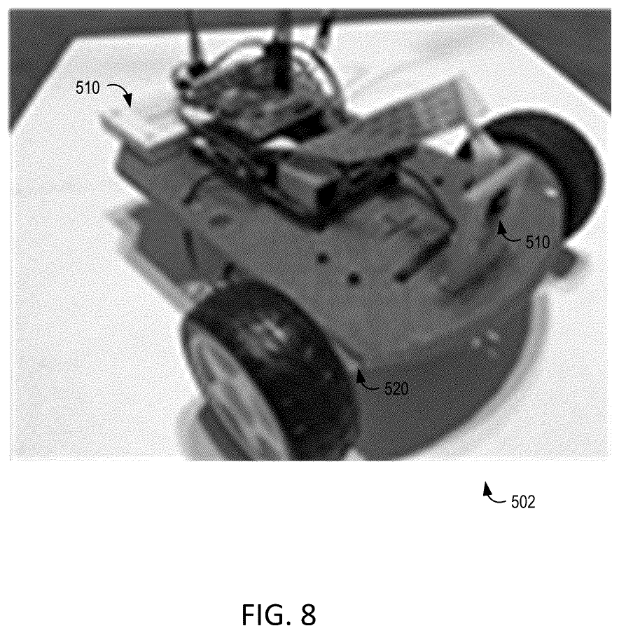

FIG. 7 shows a system 500 including a robotic device 502 in which the trivial transmitter model 100 may be implemented and/or the artificial organism may be embodied to operate the robotic device 502 in a real-world environment. FIG. 8 shows the robotic device 502. In some examples, the virtual environment shown in a run-time interface 300 (shown in FIG. 3) may be a digital representation of the real-world environment. In this manner, the run-time interface 300 may be used to monitor and/or operate the robotic device 502. For example, one or more environmental conditions in the real world may be simulated in the virtual environment, and functions and/or operations of the artificial organism simulated in the virtual environment may be replicated in the real world through the robotic device 502.

The robotic device 502 may include one or more sensors 510 and actuators 520 that interact with the environment. For example, the sensors 510 may be configured to generate and release an amount of effectives (e.g., source transmitter 114), which may vary about a mean over time, in response to detected stimuli as the robotic device 502 moves within the environment. In some examples, the frequency may be integrated with one or more frequencies from one or more other sensors 510. The robotic device 502 may include one or more controllers 530 (shown in FIG. 7) configured to receive or collect sensor information from one or more sensors 510 and process the frequency for coordinating and/or regulating information processing, perception, and/or function of the robotic device 502. For example, a controller 530 may include and/or be coupled to one or more interneuron units 120 configured to process one or more changes in the environment and generate one or more responses, which may involve activating one or more actuators 520 (e.g., for use in moving the robotic device 502 in the environment).

In some examples, the sensors 510 and/or actuators 520 may communicate with a controller 530 onboard the robotic device 502. Additionally or alternatively, at least a portion of the controller 530 may be positioned remote from the rest of the robotic device 502. For example, the controller 530 may include one or more interneuron units 120 which are communicatively coupled to the sensors 510 and/or actuators 520 via a network 540. In some examples, an onboard controller 530 (or an onboard portion of a controller 530) may use a local application that performs one or more operations locally at the robotic device 502 while one or more operations are performed remotely at a remote controller 530 (or a remote portion of a controller 530) using a counterpart remote application. The network 540 may include, without limitation, a cellular network, the Internet, a personal area network (PAN), a local area network (LAN), and/or a wide area network (WAN). In some examples, the network 540 may include one or more network devices 542 (e.g., firewall, unidirectional gateway, data diode, etc.) that facilitate protecting the robotic device 502 from external threats.

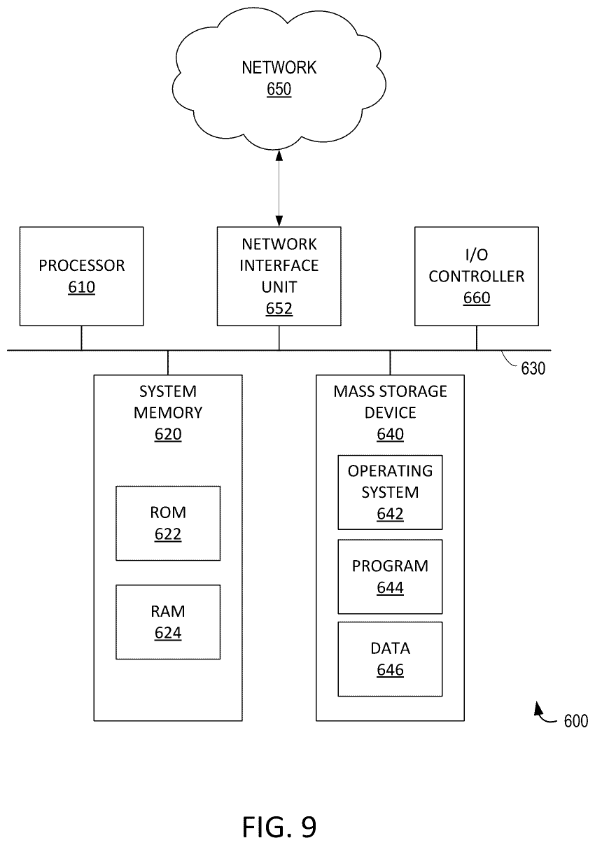

FIG. 9 shows an computing system 600 (e.g., model 100, source unit 110, source cell 112, interneuron unit 120, interneuron cell 122, motor unit 130, motor cell 132, robotic device 502, sensor 510, actuator 520, controller 530) configured to perform one or more computing operations described herein. In some examples, the computing system 600 includes a processor 610, a system memory 620, and a bus 630 coupling various system components including the system memory 620 to the processor 610.

The processor 610 is configured to perform general computing functions and process data and instructions to perform one or more operations and/or provide other functionality described herein. For example, the processor 610 may access the system memory 620 to read data and instructions from and/or write data and instructions to the system memory 620 for use in executing one or more computer-executable instructions. In this manner, the processor 610 may be programmed to execute any aspect of the software components described herein, including software components for implementing the model 100 (shown in FIG. 1), source unit 110 (shown in FIG. 1), source cell 112 (shown in FIG. 1), interneuron unit 120 (shown in FIG. 1), interneuron cell 122 (shown in FIG. 1), motor unit 130 (shown in FIG. 1), motor cell 132 (shown in FIG. 1), design-time interface 200 (shown in FIG. 2), run-time interface 300 (shown in FIG. 3), robotic device 502 (shown in FIG. 7), and/or controller 530 (shown in FIG. 7). In some examples, the processor 610 may be or include any quantity of processing units including a central processing unit, a graphics processing unit, a field-programmable gate array (FPGA), a digital signal processor (DSP), or other hardware logic components including, without limitation, an Application-Specific Integrated Circuit (ASIC), Application-Specific Standard Product (ASSP), System-on-a-Chip System (SOC), Complex Programmable Logic Device (CPLD), etc.

The system memory 620 includes any combination of computer-readable media that may be accessed by the processor 610. In some examples, the system memory 620 includes a read-only memory (ROM) 632 which stores instructions for executing basic functions and a random access memory (RAM) 634 which temporarily stores data and instructions for actively used programs. For example, the RAM 634 may be used to host or store source transmitters 114 (shown in FIG. 1), interneuron transmitters 124 (shown in FIG. 1), units 202 (shown in FIGS. 2 and 3), and/or zones 210 (shown in FIGS. 2 and 3), as well as one or more software components for implementing the model 100 (shown in FIG. 1), source unit 110 (shown in FIG. 1), source cell 112 (shown in FIG. 1), interneuron unit 120 (shown in FIG. 1), interneuron cell 122 (shown in FIG. 1), motor unit 130 (shown in FIG. 1), motor cell 132 (shown in FIG. 1), design-time interface 200 (shown in FIG. 2), run-time interface 300 (shown in FIG. 3), robotic device 502 (shown in FIG. 7), and/or controller 530 (shown in FIG. 7).

Computer-readable media includes both communication media and computer storage media. Communication media typically embody computer-readable instructions, data structures, program modules, or other data in a modulated data signal, such as a carrier wave or other transport mechanism. The term “modulated data signal” means a signal that has one or more of its characteristics set or changed in a manner as to encode information in the signal. By way of example, and not limitation, communication media includes wired media, such as a wired network or direct-wired connection, and wireless media, such as acoustic, radio frequency, and infrared media.

In contrast, computer storage media include tangible forms of media that can store information such as computer-readable instructions, data structures, program modules, or other data. By way of example, and not limitation, computer storage media includes ROM 632, RAM 634, hard disk drives (HDDs), solid-state drives (SSDs), external hard drives, flash drives, optical storage media (e.g., compact discs (CDs), digital versatile discs (DVDs), and magnetic storage media (e.g., tape drives). For purposes of the present disclosure, computer storage media is mutually exclusive to communication media and excludes waves, signals, and other transitory or intangible forms of media.

It should be appreciated that the software components described herein, when loaded into the processor 610 and executed, may transform the processor 610 and the overall computing system 600 from a general-purpose computing system into a special-purpose computing system customized to facilitate the functionality described herein. More specifically, the computer-executable instructions contained within the software components described herein transform the processor 610 to operate or function as a finite-state machine by specifying how the processor 610 transitions between states, thereby transforming the transistors or other discrete circuit elements constituting the processor 610.

Encoding the software components described herein may also transform the physical structure of the computer-readable media described herein. The specific transformation of physical structure may depend on various factors, in different implementations of the present disclosure. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the transistors, capacitors, or other discrete circuit elements constituting the semiconductor-based memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In some examples, the computing system 600 includes a mass storage device 640 coupled to the processor 610 for hosting or storing data and instructions, such as an operating system 642, one or more programs 644 (e.g., model 100, source unit 110, source cell 112, interneuron unit 120, interneuron cell 122, motor unit 130, motor cell 132), and/or data 646 (e.g., source transmitters 114, interneuron transmitters 124, units 202, zones 210). One of ordinary skill in the art would understand that copies of at least some data and/or instructions hosted or stored in the mass storage device 640 may be at least temporarily stored in the system memory 620 to enable the computing system 600 to function as described herein.

As shown in FIG. 7, the computing system 600 may connect to a network 650 (e.g., network 540) through a network interface unit 652 connected to the bus 630. In this manner, the computing system 600 may operate in a networked environment in which the computing system 600 may use one or more remote devices (not shown) to host or store at least some data and/or to execute at least some instructions. Computer communication between computing systems can be a network transfer, a file transfer, an applet transfer, an email, a hypertext transfer protocol (HTTP) transfer, and so on.

In some examples, the computing system 600 may include one or more input/output (I/O) controllers 660 that facilitate communication and data transfer between the processor 610 and one or more I/O devices (not shown) configured to provide input and/or output capabilities. For example, a user may enter commands and information into the computing system 600 using one or more input devices, such as a keyboard, pointing device (e.g., mouse, trackball, touch pad, stylus), microphone, camera, scanner, accelerometer, and the like. Additionally or alternatively, the computing system 600 may present various forms of information, such as text, images, audio, video, alerts, and the like, using one or more output devices, such as a monitor, projector, printer, speaker, actuator, and the like. In some examples, the output device may be integrated with the input device (e.g., in a touchscreen panel or in a controller including a vibrating component).

While some examples are illustrated and described herein with reference to the computing system 600 being, including, or being included in the model 100 (shown in FIG. 1), source unit 110 (shown in FIG. 1), source cell 112 (shown in FIG. 1), interneuron unit 120 (shown in FIG. 1), interneuron cell 122 (shown in FIG. 1), motor unit 130 (shown in FIG. 1), motor cell 132 (shown in FIG. 1), robotic device 502 (shown in FIG. 7), and/or controller 530 (shown in FIG. 7), aspects of the present disclosure are operable with any computing system that can execute computer-executable instructions to implement the operations and functionality associated with the computing system 600. It is also contemplated that the computing system 600 may not include all of the components shown in FIG. 7, may include other components that are not explicitly shown in FIG. 7, or may utilize an architecture completely different than that shown in FIG. 7. The computing system 600 should not be interpreted as having any dependency or requirement relating to any one or combination of components shown in FIG. 7. The computing system 600 is only one example of a computing and networking environment for performing one or more computing operations and is not intended to suggest any limitation as to the scope of use or functionality of the present disclosure.

Example methods and systems are described herein for automating one or more processes and/or managing a network. The examples described herein include a source unit for determining and releasing a first quantity of a source transmitter, an interneuron unit for determining and releasing a second quantity of an interneuron transmitter based on a quantity of received transmitters (including at least the portion of the first quantity of the source transmitter), and a motor unit for performing an action when a quantity of received transmitters (including at least the portion of the second quantity of the interneuron transmitter) satisfies a predetermined firing threshold. Example trivial transmitter models described herein convey and/or process information efficiently and/or effectively. For example, an interneuron unit may attain equilibrium by releasing synaptic inputs and/or consumer outputs. If the interneuron unit is overutilized and unable to find an inhibitory provider, then it may release one or more excitatory inputs and/or consumer outputs. If the interneuron unit is underutilized and unable to find an excitatory provider or consumer outputs, then it may release one or more inhibitory inputs or dismiss one or more cells. The strength and efficacy of synapses between units may be modified through plasticity events, when changes may occur in response to activity and/or experience, providing an ability to learn and/or create memories. In view of the above, it will be seen that several advantages of the aspects of the present disclosure are achieved and other advantageous results attained.

Although described in connection with an example computing system environment, examples of the present disclosure are capable of implementation with numerous other general purpose or special purpose computing system environments, configurations, or devices. Examples of well-known computing systems, environments, and/or configurations that may be suitable for use with aspects of the disclosure include, but are not limited to, server computers, desktop computers, laptop computers, tablets, mobile devices, communication devices in wearable or accessory form factors, microprocessor-based systems, multiprocessor systems, programmable consumer electronics, kiosks, tabletop devices, industrial control devices, minicomputers, mainframe computers, network computers, distributed computing environments that include any of the above systems or devices, and the like.

Examples of the present disclosure may be described in the general context of computer-executable instructions, such as program modules, executed by one or more computers or other devices in software, firmware, hardware, or a combination thereof. The computer-executable instructions may be organized into one or more computer-executable modules or components. Generally, program modules include, but are not limited to, routines, objects, components, and data structures that perform particular tasks or implement particular abstract data types. Aspects of the disclosure may be implemented with any number and organization of such modules or components. For example, aspects of the present disclosure are not limited to the specific computer-executable instructions or the specific components or modules illustrated in the figures and described herein. Other examples of the present disclosure may include different computer-executable instructions or components having more or less functionality than illustrated and described herein.

In some examples, the operations illustrated in the drawings may be implemented as software instructions encoded on a computer readable medium, in hardware programmed or designed to perform the operations, or both. For example, aspects of the present disclosure may be implemented as a system on a chip or other circuitry including a plurality of interconnected, electrically conductive elements.

It is possible for one or more elements of an implementation of an apparatus as described herein to be used to perform tasks or execute other sets of instructions that are not directly related to an operation of the apparatus, such as a task relating to another operation of a device or system in which the apparatus is embedded. It is also possible for one or more elements of an implementation of such an apparatus to have structure in common (e.g., a processor used to execute portions of code corresponding to different elements at different times, a set of instructions executed to perform tasks corresponding to different elements at different times, or an arrangement of electronic and/or optical devices performing operations for different elements at different times).

The order of execution or performance of the operations in examples of the present disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the present disclosure.

The examples illustrated and described herein as well as examples not specifically described herein but within the scope of aspects of the present disclosure constitute example means for managing cryptographic identities. For example, the elements illustrated in FIGS. 1, 7, and 8, when programmed, encoded, or configured to perform the operations illustrated in FIG. 6, constitute at least an example means for receiving a quantity of inbound transmitter (e.g., interneuron unit 120, motor unit 130), determining a quantity of outbound transmitter based on the quantity of inbound transmitter (e.g., interneuron unit 120), releasing a quantity of outbound transmitter (e.g., source unit 110, interneuron unit 120), and triggering a response for performing an action (e.g., source unit 110, interneuron unit 120, motor unit 130).

When introducing elements of aspects of the disclosure or the examples thereof, the articles “a,” “an,” “the,” and “said” are intended to mean that there are one or more of the elements. Furthermore, references to an “embodiment” or “example” of the present disclosure are not intended to be interpreted as excluding the existence of additional embodiments or examples that also incorporate the recited features. The terms “comprising,” “including,” and “having” are intended to be inclusive and mean that there may be additional elements other than the listed elements. The phrase “one or more of the following: A, B, and C” means “at least one of A and/or at least one of B and/or at least one of C.”

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

In the present description, reference numbers have sometimes been used in connection with various terms. Where a term is used in connection with a reference number, this may be meant to refer to a specific element that is shown in one or more of the figures. Where a term is used without a reference number, this may be meant to refer generally to the term without limitation to any particular figure.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the aspects of the present disclosure have been described in terms of various examples with their associated operations, a person skilled in the art would appreciate that a combination of operations from any number of different examples is also within the scope of the aspects of the present disclosure.

What is claimed is:

1. A method for automating one or more processes using a trivial transmitter model, the method comprising:
receiving a quantity of transmitters including at least a portion of a first quantity of a source transmitter released by a source unit;
determining a second quantity of an interneuron transmitter based on the quantity of received transmitters including at least the portion of the first quantity of the source transmitter; and
releasing the second quantity of the interneuron transmitter, wherein the second quantity of the interneuron transmitter is configured to trigger a response for performing an action upon satisfying a predetermined threshold.

2. The method of claim 1, wherein the second quantity of the interneuron transmitter is further determined based on a productive capacity, a quantity of inbound excitatory effectives, and a quantity of inbound inhibitory effectives.

3. The method of claim 1, further comprising:
determining a pressure;
comparing the pressure to a model pressure range;
on condition that the pressure is higher than the model pressure range, requesting one or more excitatory inbound synapses and offering one or more outbound synapses.

4. The method of claim 1, further comprising:
determining a pressure;
comparing the pressure to a model pressure range;
on condition that the pressure is lower than the model pressure range, one or more of generating one or more inhibitory inbound synapses, removing one or more excitatory synapses, or removing one or more outbound synapses.

5. A trivial transmitter model comprising:
a source unit configured to determine one or more parameters associated with an environment, determine a first quantity of a source transmitter based on the one or more parameters, and release the first quantity of the source transmitter;
an interneuron unit configured to receive at least a portion of the first quantity of the source transmitter, determine a second quantity of an interneuron transmitter based on a quantity of received transmitters including at least the portion of the first quantity of the source transmitter, and release the second quantity of the interneuron transmitter; and
a motor unit configured to receive at least a portion of the second quantity of the interneuron transmitter, determine whether a quantity of received transmitters including at least the portion of the second quantity of the interneuron transmitter satisfies a predetermined threshold, and on condition that the predetermined threshold is satisfied, perform an action.

6. The trivial transmitter model of claim 5, wherein the source unit, interneuron unit, and motor unit are arranged in a plurality of zones, each having a market for inhibitory synapses and a market for excitatory synapses.

7. The trivial transmitter model of claim 5, wherein one or more of the source unit, interneuron unit, or motor unit is configured to arrive in the trivial transmitter model at a predetermined time.

8. The trivial transmitter model of claim 5, wherein the source unit has a polarity defining a target zone for the first quantity of the source transmitter.

9. The trivial transmitter model of claim 5, wherein the source unit is associated with one or more of an accelerometer, a visual sensor, a thermal sensor, a pulse generator, or a test tissue.

10. The trivial transmitter model of claim 5, wherein the interneuron unit has a polarity defining a target zone for the second quantity of the interneuron transmitter.

11. The trivial transmitter model of claim 5, wherein the interneuron unit is configured to determine the second quantity of the interneuron transmitter based on a capacity of the second unit, a quantity of inbound excitatory effectives, and a quantity of inbound inhibitory effectives.

12. The trivial transmitter model of claim 11, wherein the quantity of inbound excitatory effectives is associated with a current cycle, and the quantity of inbound inhibitory effectives is associated with the current cycle and one or more previous cycles.

13. The trivial transmitter model of claim 5, wherein the interneuron unit is biased toward an equilibrium state.

14. The trivial transmitter model of claim 5, wherein the interneuron unit is configured to determine a pressure, and, on condition that the pressure is higher than a model pressure range, one or more of request one or more excitatory inbound synapses or offer one or more outbound synapses.

15. The trivial transmitter model of claim 5, wherein the interneuron unit is configured to determine a pressure, and, on condition that the pressure is lower than a model pressure range, one or more of request one or more inhibitory inbound synapses, retract one or more excitatory inbound synapses, or retract one or more outbound synapses.

16. A system comprising:
a robotic device comprising one or more sensors, one or more actuators, and one or more controllers configured to receive one or more first signals from the one or more sensors and transmit one or more second signals to the one or more actuators; and
a trivial transmitter model comprising a source unit corresponding to the one or more sensors, a motor unit corresponding to the one or more actuators, and an interneuron unit corresponding to the one or more controllers, wherein:
the source unit is configured to determine one or more parameters associated with an environment of the robotic device, determine a first quantity of a source transmitter based on the one or more parameters, and release the first quantity of the source transmitter;
the interneuron unit is configured to receive at least a portion of the first quantity of the source transmitter, determine a second quantity of an interneuron transmitter based on a quantity of received transmitters including at least the portion of the first quantity of the source transmitter, and release the second quantity of the interneuron transmitter; and
the motor unit is configured to receive at least a portion of the second quantity of the interneuron transmitter, determine whether a quantity of received transmitters including at least the portion of the second quantity of the interneuron transmitter satisfies a predetermined threshold, and on condition that the predetermined threshold is satisfied, perform an action.

17. The system of claim 16, wherein the source unit has a first polarity defining a first target zone for the first quantity of the source transmitter, and the interneuron unit has a second polarity defining a second target zone for the second quantity of the interneuron transmitter.

18. The system of claim 16, wherein the interneuron unit is configured to determine the second quantity of the interneuron transmitter based on a capacity of the second unit, a quantity of inbound excitatory effectives, and a quantity of inbound inhibitory effectives.

19. The system of claim 16, wherein the interneuron unit is configured to:
determine a pressure;
on condition that the pressure is higher than a model pressure range, request one or more excitatory inbound synapses and offer one or more outbound synapses; and
on condition that the pressure is lower than the model pressure range, request one or more inhibitory inbound synapses.
